(19) United States
(12) Patent Application Publication
(10) Pub. No.: US 2010/0315233 A1
(43) Pub. Date: Dec. 16, 2010

(54) Dead bolt lock reminder triggered by proximity detector

(76) Inventors: Joseph Eichenstein, Lakewood, NJ (US); John V. Mizzi, Poughkeepsie, NY (US)

Correspondence Address: ALFRED M. WALKER, 225 OLD COUNTRY ROAD, MELVILLE, NY, 11747-2712, US

(21) Appl. No.: 12/584,202

(22) Filed: Sep. 1, 2009

Related U.S. Application Data
(63) Continuation-in-part of application No. 12/456,218, filed on Jun. 13, 2009.

(51) Int. Cl. E05B 45/06

(52) U.S. Cl. 340/542

(57) ABSTRACT

A deadbolt lock reminder system includes a normally closed deadbolt detector switch which supplies power to a proximity detector to detect a presence of a person in a vicinity of a door whenever the dead bolt is detected not to be in a locked position. When the person leaves the vicinity of the door, the proximity detector switches into a “person no longer detected” mode thereby triggering an alarm. The sounding of the alarm will remind the person to return to lock the dead bolt. The alarm sounds for a fixed duration while the person is still within earshot of the alarm.

### RELATED APPLICATIONS

This application is a continuation-in-part of application Ser. No. 12/456,218, filed on Jun. 13, 2009, which application is incorporated by reference herein. This application claims priority in part under 35 U.S.C. §120 therefrom.

### FIELD OF THE INVENTION

The present invention relates to low cost reminders that a dead bolt lock of a building door is unlocked.

### BACKGROUND OF THE INVENTION

At times, people leaving a house or apartment may simply forget to use their key to lock the dead bolt of their front door. At other times they may be distracted by a cell phone call or a toddler in tow. The door security would then be left to an easily penetrated snap latch lock.

Although several patents in the prior art relate to proximity detectors of people in a vicinity, none are used to trigger a simple alarm at the door if the dead bolt had not been locked.

U.S. Pat. No. 5,659,291 to Kennedy, et al., is a key-in-ignition reminder system which controls automatic locking and unlocking of vehicle doors depending on conditions after it is determined that a key has been left in an ignition lock. An alarm warning the driver is also provided. The key, with a built-in transponder, communicates a key code via local radio transmission. Although a proximity switch is mentioned in the patent, (see column 2 lines 50-51), the proximity switch is a “door proximity switch” that is used to determine if vehicle door is open or closed. This door proximity switch is understood to comprise a set of switch contacts or a magnet and sensor arrangement, but is not a capacitive proximity detector. That is, Kennedy '291 does not suggest dead bolt or person detection for a home or business structure.

U.S. Pat. No. 5,608,378 to McLean, et al., discloses either a wired or wireless electric stove warning system to remind a person leaving through a door that the stove is “on”. The detection of a person leaving is either by a weight actuated door mat switch or by a door switch in the door jamb. (See McLean's column 3 line 65 through column 4 line 15). Mclean makes no disclosure or suggestion of a dead bolt or proximity detector, although an alarm (visual and/or sound) at the door is described.

U.S. Pat. No. 5,565,843 to Meyvis is an unrelated garage door message display. It warns of a garage door being unlocked and other conditions.

U.S. Pat. No. 6,032,500 to Collard, Jr., et al., discloses a kit for retrofitting a door with a security lock system. The block diagram of FIG. 5 shows block 130 described as a dead bolt position sensor. The dead bolt sensor is shown communicating with a remote door lock control logic and relays/drivers (block 150), described in column 4, lines 64-65, although reference numbers are incorrect. Collard's column 6, lines 11-12, discloses a “proximity switch” that is called out as a substitute type to sense lock position. Such a lock position sensor, however, would not be possible using a proximity detector designed to sense the presence of a person.

U.S. Pat. No. 6,705,940 to Moore describes a portable doorway bug deflector. Except for being a fan operated unit mounted on the side of a doorway and controlled by a door switch, this patent is completely unrelated to the invention. There is no notion of dead bolt, reminder warning, or proximity detector.

U.S. Pat. No. 6,166,634 to Dean describes a garage door status signaling device that uses a transmitter to send a signal to a remote audio visual display, and includes a receiver and a timer which again restarts the audio if the door is still open (column 1, lines 45-46; column 2, lines 41-47. There is no disclosure or suggestion of proximity detectors or dead bolts.

U.S. Pat. No. 6,731,200 to Wagner, et al., is a system for indicating the status of a hotel room for such things as “do not disturb” or “maid service”. While the Wagner system may be battery powered, it is preferably wired into the “hotel's electrical system;” column 4, lines 35-38. Functions are microprocessor controlled and an alarm switch input can come from a “newly installed door proximity switch or from a motion sensor;” column 5, lines 36-37. Other references to motion sensors and infrared motion or heat sensors are found in column 6, but reflect the use of displays and people sensors at the door, which not only complicate intended operation, but significantly increase cost. No disclosure or notion of dead bolt position sensing is found in Wagner.

U.S. Pat. No. 6,857,671 to Fly discloses an electromagnetic locking device for a door. Although a “proximity switch” is mentioned in the patent, Fly's proximity switch is designed to sense the displacement of the electromagnet housing to detect tampering. There is no disclosure, suggestion or notion of audio/visual reminder, people sensing, or dead bolts.

U.S. Pat. No. 7,037,034 to Dillingham discloses a hydraulic safety door system for a hopper body, but is not related in any way. It is unrelated to doors using dead bolts. Dillingham at column 5, lines 17-24, describes a proximity switch using switch contacts, which does not comprise a capacitive proximity sensor for detecting a person.

U.S. Pat. No. 7,205,777 to Shultz, et al., discloses an improved capacitive proximity switch, which is described in relation to applications to a motor vehicle door handle. The detector itself is said to display improved reliability, especially in rain conditions.

U.S. Pat. No. 7,234,201 to Brown, et al., discloses a door closer power adjusting device that uses an electric motor to adjust the closing and opening force of a closer that is similar to a manual spring operated automatic door closer (often used on conventional screen doors). Brown's operating switch is described in the form of a “motion detector” or an “infra red proximity switch” (column 2, lines 6-12), but does not disclose or suggest the use of a dead bolt or reminder.

U.S. Pat. No. 7,372,355 of Agronin, et al., discloses a remote controlled wall switch actuator. FIGS. 5A-5D present a block diagram with block 176 labeled as a motion or proximity sensor, which can be used to operate the wall switch remotely by wireless signal (column 8, line 34). While there is mention of the word “lock” within this patent, it is within the context of “lock-out” (column 9, lines 37-38), but Agronin does not disclose or suggest a door, dead bolt lock, or reminder alarm.

U.S. Pat. No. 7,378,980 to McFarland discloses triangulation of position for automated building control components. McFarland's FIG. 1 shows a block diagram of a building automation device, wherein block 12 is a sensor/actuator. In column 1, lines 42-43, McFarland discloses that the sensor “also may be a limit or proximity switch.” Otherwise, however, the subject matter of McFarland is quite divorced from door locks or reminders.

U.S. Pat. No. 7,448,246 to Briese, et al., discloses a machine for window frame corner fabrication, including mechanical switches which detect position of moving machine elements, but does not teach or suggest doors, dead bolt locks and/or reminder alarms.

U.S. Pat. No. 7,450,012 to Harmon discloses an unrelated RFID reader/writer device.

U.S. Pat. No. 7,380,375 to Maly discloses an alarm system for a loading dock. The Maly alarm system uses a “remote body sensor,” which can be a “motion detector”, “infrared sensor” or “ultrasonic proximity sensor” (FIG. 6, item 70; column 4, lines 49-56). In effect, Maly's alarm system operates similarly as does a typical motion sensor driveway light fixture.

U.S. Pat. No. 7,466,040 to Bruwer discloses a touch sensor controlled switch with intelligent user interface. The switch with intelligent interface comprises a group of “microchip” (see FIG. 2) applications and uses a combination of touch or proximity switches with ordinary slide or pushbutton switches to do a wide variety of things, e.g., “find in the dark”, act as an intelligent flashlight, or even toys (which can already be found on store shelves). Bruwer's column 6, lines 2-11, describes toys and child activation through proximity action. Column 6, lines 31-34, describes reference values in capacitive sensing such as would be used in this and any other capacitive proximity detector application.

### OBJECTS OF THE INVENTION

It is an object of the present invention to provide a dead bolt lock reminder that overcomes the shortcomings of the prior art.

It is another object of the present invention to provide a dead bolt lock reminder triggered by a proximity detector upon sensing the instant of a person leaving the immediate vicinity while the dead bolt is in an unlocked state.

It is yet another object of the invention to provide a deadbolt lock reminder which includes a normally closed deadbolt detector switch that supplies power to a proximity detector that detects a presence of a person in a vicinity of a door whenever the dead bolt is not locked.

It is still another object of the invention to provide a door lock alarm wherein a proximity detector switches into a “person no longer detected” mode, which thereby sounds an alarm to remind the person to return to lock the dead bolt.

It is still yet another object of the invention to provide a door lock alarm with a timer period which elapses while the person is still within earshot of the alarm.

### SUMMARY OF THE INVENTION

Building doors are typically locked with a key engaging dead bolt lock, which has a movable dead bolt for locking the door. Upon activation by the key, the dead bolt moves from a retracted unlocked position inside the dead bolt lock housing located within the door, to an extended locking position when the dead bolt penetrates a recess in the door jamb surrounding the door, thereby preventing the door from opening.

To that end, the present invention provides a deadbolt lock reminder that uses a normally closed switch to detect the position of a dead bolt in a locked state, which would be opened by it since the switch is strategically placed in the dead bolt recess. If the switch is in its normally closed state, the switch enables power from a battery source, e.g., two or more alkaline AA cells, to operate a proximity detector to detect a person in its vicinity. Preferably, a capacitive type proximity detector is used in view of its low cost and low battery drain, e.g., known proximity detectors used to trigger visual and audio displays in novelty items such as Halloween and Christmas decorations that are initialized automatically when a person is detected in the vicinity of the decoration. Other types of proximity detectors such as ultrasonic or infrared types may also be used. With added complexity, a microprocessor can be programmed to detect proximity using a related type of motion detector, but this is not necessary for the present invention.

In operation, when a person leaves through a door, the dead bolt is necessarily unlocked so the proximity detector is operating and would immediately detect the presence of a person. If the person locks the dead bolt, the switch is thereby opened which deactivates the proximity detector and associated circuitry. So as the person leaves, no alarm is sounded. However, if the person leaves the area without locking the dead bolt, the absence of the person triggers a single shot timer with a delay of approximately a second or less. At the end of that time period, an alarm sounds (for a timed period) alerting the person to his or her negligence (i.e., negligence in failing to secure the lock) while he or she is still within earshot of the alarm.

If the person returns within the timer period, the proximity detector detects their presence and switches state, which blocks the alarm and possibly re-triggers when the person “leaves” for a second (or “third”) time without locking the door. This single shot timer scheme eliminates many nuisance alarms resulting from brief non-detection periods that can be triggered by bending down to pick something up, for example.

The dead bolt lock reminder “reminds of failure to deadbolt” with least annoyance when used at doors that are intended during normal operation to be in the state of being locked by a dead bolt most of the time. The dead bolt lock reminder is enabled whenever the dead bolt is opened, e.g., either by an indoor latch or by a key from outdoors. However, if the deadbolt is locked either from the inside or outside before the person leaves the vicinity, no alarm is triggered.

The invention is readily distinguishable from known prior art (e.g., Bruwer) because unlike the present invention of Applicant herein, the aforementioned prior art of Bruwer '040 uses a proximity detector typically as a “touch switch” with the sensor connector connected to a touched item. Note that in the present invention, the dead bolt is not connected to the sensor of the proximity detector, nor does the dead bolt behave as a “touch switch”. That is, the proximity sensor is included in the inventive dead bolt lock reminder simply to detect the presence of a person in the vicinity of the door to be dead bolted.

The dead bolt lock reminder, unlike Bruwer, does not propose doing dynamic “touch/no-touch” level adjustments via a special chip, nor does it have a heavy load such as a motor or flashlight. That is, the dead bolt lock reminder need only drive an audio alarm such as, for example, a piezoelectric annunciator that is activated for a timed period at the detection of a non-presence of a person. Also in Bruwer, a timer may be activated when a no-touch condition is sensed by the proximity/touch sensor causing the load to be deactivated. In contrast, in the present invention, the alarm is activated by the “no-person condition.”

### BRIEF DESCRIPTION OF THE DRAWINGS

The present invention can best be understood in connection with the accompanying drawings. It is noted that the invention is not limited to the precise embodiments shown in drawings, in which:

FIG. 1 is a front elevation detail of a portion of the door from the outside showing the outdoor mounting of the reminder system of this invention.

FIG. 2 is front elevation detail of a portion of the door from the outside showing the mounting of an outdoor capacitive plate and sound emitter when the reminder system is located inside.

FIG. 3 is a block diagram of the reminder system of this invention.

### DETAILED DESCRIPTION OF THE INVENTION

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention, as defined by the appended claims. The descriptions below are designed to make such embodiments obvious to a person of ordinary skill in the art.

Building door 4 is locked with a key engaging dead bolt lock 6 within door 4. Door lock 6 has a movable dead bolt (not shown) for locking the door 4. Upon activation by the key, the dead bolt moves from a retracted unlocked position inside the housing of dead bolt lock 6, which is located within the door 4, to an extended locking position when the dead bolt penetrates a recess in the door jamb in wall 3 surrounding the door 4, thereby preventing the door 4 from opening.

The deadbolt lock reminder system comprises a normally closed deadbolt detector switch 21 which supplies power from battery 20 to a proximity detector 22 detecting the presence of a person in the vicinity of the door 4 whenever the dead bolt is not locked,

a) wherein when the person leaves the vicinity of the door 4, the proximity detector 22 switches into a “person no longer detected” mode,

b) wherein further an alarm 29 will commence sounding reminding the person to return to lock the dead bolt 6 while the person is still within earshot of the alarm 29.

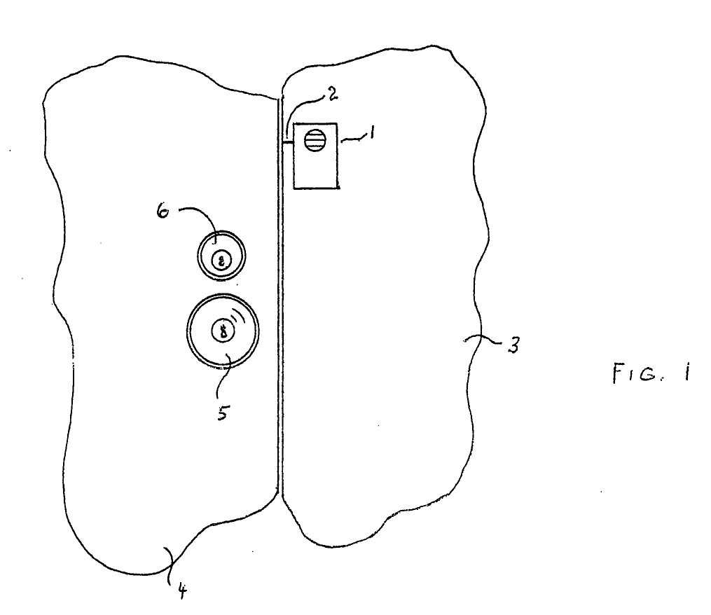

A deadbolt lock proximity detector reminder system 1 is shown in FIG. 1 mounted adjacent a door 4 on an outside wall 3. A housing contains all components except for the dead bolt switch which is in the dead bolt recess in line with lock 6, and wired to system 1 via wire 2 in the door jamb. The front surface of housing 1 is conductive, and therefore acts as the detection surface. An extension surface inside the door jamb and partially inside may be required for acceptable performance in some cases. Door knob 5 is in its typical location with optional snap latch lockset.

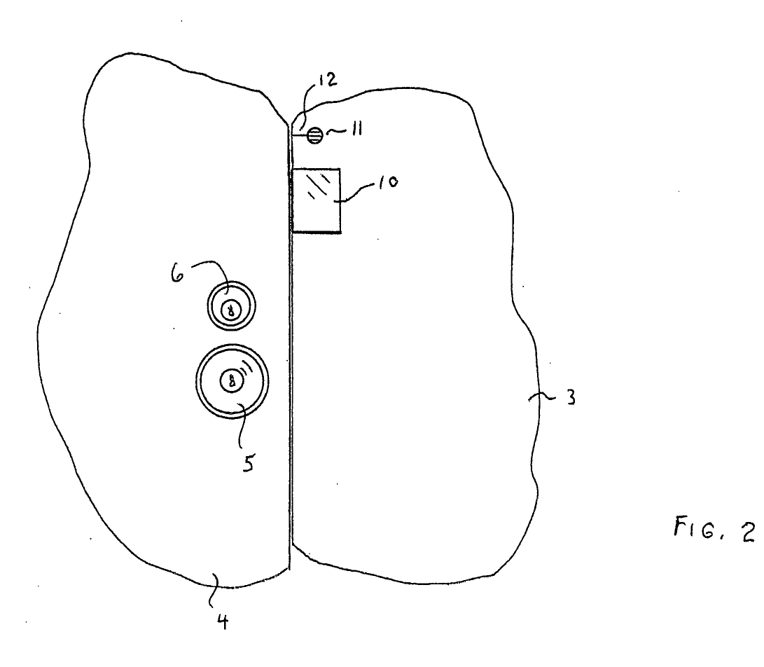

FIG. 2 depicts an alternative embodiment of deadbolt reminder system 1, which is mounted at the door 4, but the housing for most of the components is inside. A conductive capacitive plate extension 10 wraps around the door jamb shown in FIG. 2 from outside to inside and is then wired to the indoor housing. A two wire cable 12 consisting of two wires in a cable in FIG. 2 leads from the indoor housing to a loud externally mounted sound emitter 11, such as a piezoelectric type. Plate 10 can be easily made of an insulating layer with an adhesive on its back side (with release liner) and a thin aluminum foil outer layer. The foil layer may be painted with a flat finish.

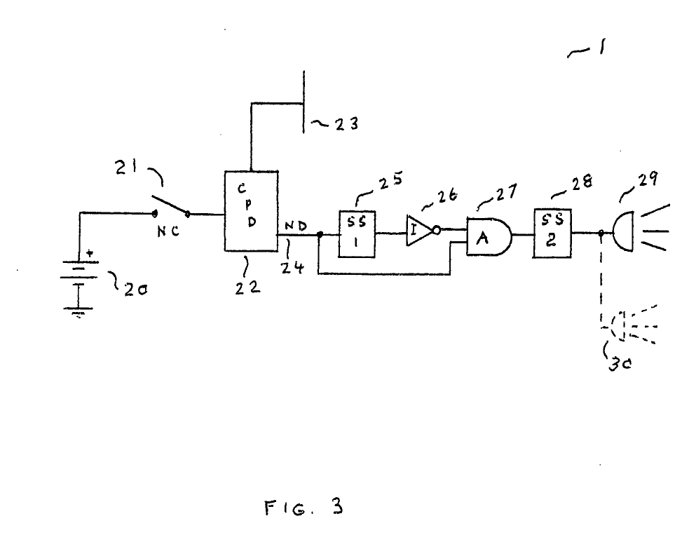

A functional circuit block diagram for reminder system 1 is depicted in FIG. 3. The circuit includes a battery 20 that powers the reminder system 1. Switch 21, as shown, is equivalent to the dead bolt locked position detection switch, which enables the battery 20 to power the entire system, only when the dead bolt is unlocked (since it is a normally closed switch opened by being impinged upon by the dead bolt in its locking recess). The operation is described assuming the dead bolt is unlocked. A capacitive proximity detector 22 as shown includes a capacitive detection plate 23 which is used to detect the presence of a person in the vicinity of the detector. Output 24 is enabled if the capacitance drops to a voltage level below the threshold of “No person Detected”.

At that point, a first single shot (SS1) 25 is triggered, an output of which immediately goes high for a predetermined period of time, such as, about a second. The output signal is inverted at inverter (“I”) 26, the inverted signal fed to one input of “AND” circuit 27. The other input to AND circuit 27 is the “ND” signal 24. Consequently, the output of “AND” circuit 27 is inhibited as long as single shot 25 has not timed out, or the non detection signal is no longer valid. If the condition of the single shot (SS1) 25 has timed out, and “ND” signal 24 is still valid, the output of “AND” circuit 27 switches high thereby triggering single shot (SS2) 28. The triggering times out the signal to a sound emitter 29, which sounds for the set length of further single shot (SS2; 28). A second smaller (or less loud) optional indoor alarm 30 is shown in dashed lines, which is used in an alternative embodiment.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

We claim:

1. A deadbolt lock reminder system, comprising:
a door having a dead bolt in a dead bolt lock for locking the door, said dead bolt moving from a retracted unlocked position inside said lock within said door to an extended locking position when said dead bolt penetrates a recess in the door jamb surrounding the door;
a proximity detector;
a normally closed deadbolt detector switch which supplies power from a battery to the proximity detector and detects a presence of a person in a vicinity of the door whenever the dead bolt is not arranged in a locked position,
wherein said proximity detector detects when said person leaves a vicinity of said door and therefore switches into a “person no longer detected” mode and triggers an alarm to remind said person to return to lock the dead bolt lock while said person is still within earshot of said alarm.

2. The deadbolt lock reminder as in claim 1, wherein said normally closed proximity detector switch is placed in the dead bolt recess of said lock.

3. The dead bolt lock reminder as in claim 2, wherein when said normally closed proximity detector switch is in its normally closed state, power is available from a battery source to operate said proximity detector and alarm circuitry.

4. The dead bolt lock reminder as in claim 1, wherein said proximity detector is a capacitive type.

5. The dead bolt lock reminder as in claim 1, wherein said normally closed proximity detector switch is ultrasonic.

6. The dead bolt lock reminder as in claim 1, wherein said normally closed proximity detector switch is infrared.

7. The dead bolt reminder as in claim 1, further comprising a microprocessor programmed to detect proximity using a motion detector.

8. The dead bolt reminder as in claim 1, wherein as said person leaves through the door 4 at a time at which the dead bolt lock is an unlocked state, said proximity detector detects the presence of the person, wherein if the person locks the dead bolt lock, said proximity detector switch is opened thereby deactivating said proximity detector, and no alarm is sounded, and wherein if the person does not lock the dead bolt lock, a single shot timer with a short time delay period is triggered such that at the end of the short time delay period an alarm sounds for a predetermined timed period alerting the person that said lock is unlocked.
